(19) United States
(12) Patent Application Publication
(10) Pub. No.: US 2024/0198775 A1
(43) Pub. Date: Jun. 20, 2024

(54) ELECTRIC DRIVE AXLE FOR A VEHICLE

(71) Applicant: Valeo eAutomotive Germany GmbH, Erlangen (DE)

(72) Inventors: Sebastian BROEDLER, Erlangen (DE); Diego SCHIERLE, Erlangen (DE)

(73) Assignee: Valeo eAutomotive Germany GmbH, Erlangen (DE)

(21) Appl. No.: 18/539,866

(22) Filed: Dec. 14, 2023

(30) Foreign Application Priority Data
Dec. 14, 2022 (DE) 10 2022 133 350.7

(51) Int. Cl. B60K 1/00

(52) U.S. Cl. CPC B60K 1/00; B60K 2001/001

(57) ABSTRACT

An electric drive axle for a vehicle, having an electric motor, a gearbox, a differential with two output shafts and a separating clutch, the input side of which is coupled to one of the output shafts of the differential and the output side of which is assigned to one of two drive shafts of the drive axle. A mechanical oil pump is provided, which is coupled to one of the two drive shafts by means of a shifting clutch. A module for such a drive axle includes a gearbox and an oil pump which is coupled to the gearbox in such a manner that the oil pump has a delivery capacity only when the gearbox does not transmit drive power.

The invention relates to an electric drive axle for a vehicle, having an electric motor, a gearbox, a differential having two output shafts and a separating clutch, the input side of which is coupled to one of the output shafts of the differential and the output side of which is assigned to one of two drive shafts of the drive axle.

Such a drive axle can be used, for example, for a hybrid vehicle to drive the vehicle with electrical energy if required. This can, for example, extend the range. It is also conceivable that the drive axle is used for a four-wheel drive vehicle, whereby it is then engaged on demand.

If the drive axle is to provide drive power, the separating clutch is closed, so that the input side of the separating clutch is coupled to the output shaft of the differential and a drive torque applied to the differential is transmitted to the output side of the separating clutch and from there to the drive shaft of the corresponding wheel. When no drive power is required, the separating clutch is opened so that the drive shaft of one of the drive axle wheels is decoupled from the assigned output shaft of the differential. When the vehicle is in motion in this state, an output shaft of the differential is entrained directly by the drive shaft in which there is no separating clutch. However, because the electric motor and the gearbox produce a certain drag torque, the cage of the differential is decelerated or stopped in such a way that the opposite output shaft of the differential is driven. However, this is possible without any problems, as the output shaft on this side can rotate completely freely due to the open separating clutch.

The advantage of such a drive axle with separating clutch is that, when the electric motor is not needed, said drive axle has an extremely low drag torque, i.e. substantially the loss of friction in the differential.

However, it has been demonstrated that in an operating state with the separating clutch open, the differential is no longer supplied with sufficient oil, as the gearbox is not driven and therefore an oil pump usually present in the gearbox is also not driven.

The object of the invention is to improve the electric drive axle in such a way that damage to the differential is prevented when the electric drive axle is operated with the separating clutch open.

In order to solve this problem, provided according to the invention in an electric drive axle of the type mentioned at the outset is a mechanical oil pump, which is coupled to one of the two drive shafts by means of a shifting clutch. The invention is based on the basic concept of providing an additional oil pump which receives its drive power from one of the drive shafts, i.e. is driven passively by one of the wheels of the drive axle. As soon as the electric drive axle is operated passively with the separating clutch open, i.e. the wheels rotate without the electric motor being supplied with energy, the drive energy required to operate the oil pump can be drawn from the drive shafts even when the separating clutch is open.

According to one embodiment of the invention, it is provided that the oil pump is assigned to the drive shaft directly coupled to the differential. The oil pump can then either always run conjointly, i.e. independently of the state of the separating clutch, or an additional clutch can be provided by way of which the oil pump is coupled to the drive shaft on demand.

According to a preferred embodiment of the invention, it is provided that the oil pump is assigned to the drive shaft coupled to the differential by way of the separating clutch. This makes it possible to operate the oil pump with little effort, depending on the state of the separating clutch.

In particular, it can be provided that the oil pump is assigned to the separating clutch. The oil pump can be connected to the separating clutch so as to form a common module, or the shifting clutch can also be fully integrated in the separating clutch, so that complexity in terms of assembling is reduced.

According to a preferred embodiment of the invention, it is provided that the shifting clutch is coupled to the separating clutch in such a way that the oil pump is coupled to the drive shaft when the separating clutch is in the open position, and vice versa. This automatically puts the oil pump into operation when the separating clutch is opened, i.e. the gearbox is no longer entrained by the drive wheels. This automatically supplies oil to the differential when the drive axle is operated passively, preventing unwanted wear.

A synchronization mechanism may be provided, which—when opening the separating clutch—equalizes the rotating speed of an input side and output side of the shifting clutch. This achieves the result that the oil pump will start smoothly when the separating clutch is opened.

The oil pump, by way of its inlet, preferably inducts directly from an oil sump of the gearbox in such a way that the oil pump can resort to the oil reservoir of the gearbox.

The oil pump preferably has an outlet which is connected to an oil outlet in the gearbox that is associated with the differential. Since only the differential rotates within the gearbox when the separating clutch is open, it is also sufficient for only the differential to be lubricated. The oil pump therefore needs to provide only a very low throughput.

Provided in order to achieve the above-mentioned object is also a module for such a drive axle, wherein the module has a gearbox and an oil pump which is coupled to the gearbox in such a manner that said oil pump has a delivery capacity only when the gearbox does not transmit drive power. In terms of the resultant advantages, reference is made to the above explanations.

Preferably, the module has a separating clutch and two drive shafts, wherein a shifting clutch is provided by way of which the oil pump can be coupled to one of the drive shafts.

The invention will be described below by means of an embodiment which is illustrated in the appended drawings. In the drawings:

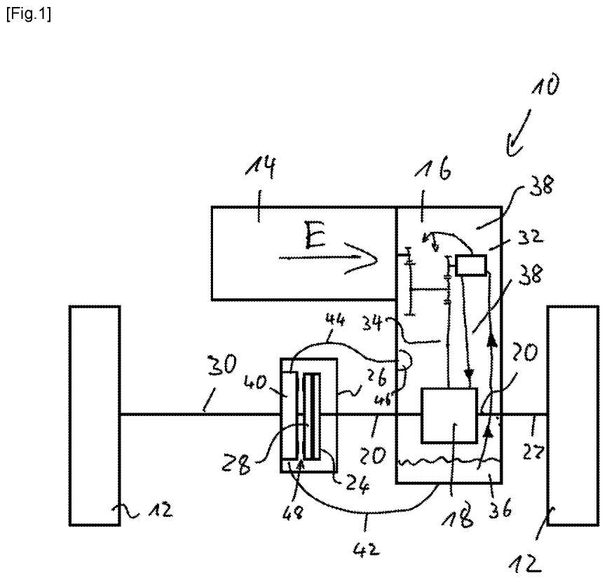

FIG. 1 shows a drive axle according to the invention in a first operating state; and

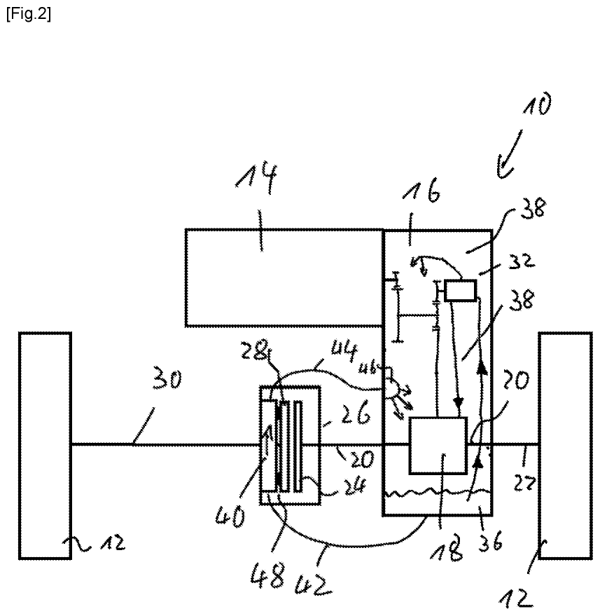

FIG. 2 shows the drive axle of FIG. 1 in a second operating state.

Shown in FIG. 1 is an electric drive axle 10 by way of which two schematically shown wheels 12 of a vehicle (not shown here) can be driven.

The drive axle 10 has an electric motor 14 which transmits electrical drive energy by way of a gearbox 16 to a differential 18 integrated in the gearbox 16. The differential 18 has two output shafts 20, of which one here (the right-hand one) transitions directly into a drive shaft 22 that leads to the corresponding wheel 12.

The output shaft 20 disposed on the opposite side leads to the input side 24 of a separating clutch 26. The output side 28 of the separating clutch 26 is connected to a second drive shaft 30 that leads to the second wheel 12.

Provided within the gearbox 16 is an oil pump 32 which is connected to a gearbox shaft 34 and is therefore operated when the electric motor 14 is operated. The oil pump 32 then pumps oil from an oil sump 36 into oil supply lines 38 that lead to the desired lubricating points within the gearbox and near the differential.

Disposed inside the separating clutch 26 is a further oil pump 40. When the latter is operated, it draws oil from the oil sump 36 through its inlet via a line 42. The oil provided at its outlet is guided by way of a supply line 44 to an oil outlet 46 (for example, a spray nozzle) within the gearbox 16, wherein the oil outlet is specifically assigned to the differential 18. The oil pump 40, which is disposed within the separating clutch 26, can be connected to either the drive shaft 30 or the output side 20 of the differential 18 by means of a shifting clutch 48. In the exemplary embodiment shown, the oil pump 40 can be connected to the output side 28 of the separating clutch 26.

In the state shown in FIG. 1, the separating clutch 26 is closed. In this state, the shifting clutch 48 is open.

The electric motor 14 drives the gearbox 16 (symbolized by the arrow E). The drive torque is distributed by way of the gearbox and the differential to the two drive shafts 22, 30, wherein the oil pump 32 in the gearbox is directly driven by the gearbox shaft 34. Therefore, all components within the gearbox are lubricated by the oil pump 32.

In FIG. 2, the drive axle of FIG. 1 is shown in a state in which the separating clutch 26 is open. At the same time, the electric motor 14 is switched off. If the vehicle is nevertheless moved, for example, by an internal combustion engine which is assigned to a second drive axle, a rotating movement is introduced into the differential 18 by way of the drive shaft 22. However, since the cage of the differential is coupled to the electric motor 14 by way of the gearbox 16, the cage does not co-rotate. Thus, a rotation of the drive shaft 22 only leads to a rotation of the output side 20 of the differential 18 and of the input side 24 of the separating clutch 26.

However, when the separating clutch 26 is in its open state, the oil pump 40 is coupled to the output side 28 of the separating clutch 26 by way of the shifting clutch 48. Therefore, the oil pump 40 is driven by the rotating movement of the drive shaft 30 coupled to the output side 28 of the separating clutch 26 (assuming that the vehicle is moving and therefore the wheel 12 is rotating). This creates an oil flow that only supplies the differential 18 with oil. The oil outlet 46 sprays the pumped oil directly onto the differential, as is indicated by the arrows in FIG. 2.

The shifting clutch 48 can be embodied in various ways. For example, it may be a mechanical clutch that is closed when the separating clutch opens, i.e., for example, the output side 28 in the form of a clutch plate is displaced to the left. It is also possible that the shifting clutch 48 is a separate clutch that is closed by an actuator when the separating clutch 26 is opened.

A synchronizing device similar to a synchronizing device for a manual gearbox can also be integrated in the shifting clutch 48, so as to ensure that the oil pump 40 is smoothly started when the separating clutch 26 is opened.

1. Electric drive axle for a vehicle, having an electric motor, a gearbox, a differential with two output shafts and a separating clutch, the input side of which is coupled to one of the output shafts of the differential and the output side of which is assigned to one of two drive shafts of the drive axle, characterized in that a mechanical oil pump is provided, which is coupled to one of the two drive shafts by means of a shifting clutch.

2. Drive axle according to claim 1, wherein the oil pump is assigned to the drive shaft directly coupled to the differential.

3. Drive axle according to claim 1, wherein the oil pump is assigned to the drive shaft coupled to the differential by way of the separating clutch.

4. Drive axle according to claim 3, wherein the oil pump is assigned to the separating clutch.

5. Drive axle according to claim 4, wherein the shifting clutch is integrated in the separating clutch.

6. Drive axle according to claim 4, wherein the shifting clutch is coupled to the separating clutch in such a way that the oil pump is coupled to the drive shaft when the separating clutch is in the open position, and vice versa.

7. Drive axle according to claim 6, wherein a synchronization mechanism is provided, which—when opening the separating clutch—equalizes the rotating speed of an input side and an output side of the shifting clutch.

8. Drive axle according to claim 1, wherein the oil pump has an inlet which inducts from an oil sump of the gearbox.

9. Drive axle according to claim 1, wherein the oil pump has an outlet which is connected to an oil outlet in the gearbox that is assigned to the differential.

10. Module for a drive axle according to claim 1, wherein the module has a gearbox and an oil pump which is coupled to the gearbox in such a manner that it has a delivery capacity only when the gearbox does not transmit drive power.

11. Module according to claim 11, wherein said module comprises a separating clutch and two drive shafts, wherein a shifting clutch is provided by way of which the oil pump can be coupled to one of the drive shafts.

12. Drive axle according to claim 5, wherein the shifting clutch is coupled to the separating clutch in such a way that the oil pump is coupled to the drive shaft when the separating clutch is in the open position, and vice versa.

13. Drive axle according to claim 2, wherein the oil pump has an inlet which inducts from an oil sump of the gearbox.

14. Drive axle according to claim 2, wherein the oil pump has an outlet which is connected to an oil outlet in the gearbox that is assigned to the differential.

15. Module for a drive axle according to claim 2, wherein the module has a gearbox and an oil pump which is coupled to the gearbox in such a manner that it has a delivery capacity only when the gearbox does not transmit drive power.

16. Drive axle according to claim 3, wherein the oil pump has an inlet which inducts from an oil sump of the gearbox.

17. Drive axle according to claim 3, wherein the oil pump has an outlet which is connected to an oil outlet in the gearbox that is assigned to the differential.

18. Module for a drive axle according to claim 3, wherein the module has a gearbox and an oil pump which is coupled to the gearbox in such a manner that it has a delivery capacity only when the gearbox does not transmit drive power.

19. Drive axle according to claim 4, wherein the oil pump has an inlet which inducts from an oil sump of the gearbox.

20. Drive axle according to claim 4, wherein the oil pump has an outlet which is connected to an oil outlet in the gearbox that is assigned to the differential.
